(19) United States
(12) Patent Application Publication
(10) Pub. No.: US 2013/0343767 A1
(43) Pub. Date: Dec. 26, 2013

(54) OPTICAL TRANSMITTER

(71) Applicant: Mitsubishi Electric Corporation, Tokyo (JP)

(72) Inventors: Satoshi Kajiya, Tokyo (JP); Tatsuo Hatta, Tokyo (JP); Yuto Ueno, Tokyo (JP)

(21) Appl. No.: 13/908,030

(22) Filed: Jun. 3, 2013

(30) Foreign Application Priority Data
Jun. 25, 2012 (JP) 2012-142078

(51) Int. Cl. H04B 10/564

(52) U.S. Cl. CPC H04B 10/564
USPC 398/183

(57) ABSTRACT

An optical transmitter includes an equalizer which receives a data signal, an optical modulator driver which amplifies an output signal of the equalizer, and an optical modulator which converts an output signal of the optical modulator driver into an optical signal and outputs the optical signal. The equalizer has a signal line for transmitting the data signal, a coupled line electromagnetically coupled to the signal line, a resistive section connected to the coupled line, and a ground via connected to the resistive section. The equalizer reduces power of the data signal in a frequency range where the frequency response characteristic of the optical modulator driver exhibits peaking, to reduce waveform jitter in the output signal of the optical modulator driver that is input to the optical modulator.

### BACKGROUND OF THE INVENTION

1. Field of the Invention

The present invention relates to an optical transmitter for use in optical communications, etc.

2. Background Art

Japanese Laid-Open Patent Publication No. 2005-252783 discloses a technique in which a data signal that has been amplified by an optical modulator driver is converted into an optical signal by a semiconductor laser device.

Some optical modulator drivers have a characteristic called “peaking” in which the magnitude of their frequency response characteristics is significantly higher in a specific frequency range than in other frequency ranges. It has been found that this peaking characteristic of an optical modulator driver may serve to degrade the quality of the data signal that has been input to the driver, causing waveform jitter. Data errors have been found to occur if such waveform jitter is significant.

### SUMMARY OF THE INVENTION

The present invention has been made to solve the above problems. It is, therefore, an object of the present invention to provide an optical transmitter capable of minimizing waveform jitter due to peaking in the frequency response characteristic of its optical modulator driver.

The features and advantages of the present invention may be summarized as follows.

According to one aspect of the present invention, an optical transmitter includes an equalizer which receives a data signal, an optical modulator driver which amplifies output of the equalizer, and an optical modulator which converts output of the optical modulator driver into an optical signal and outputs the optical signal. The equalizer has a signal line for transmitting the data signal, a coupled line electromagnetically coupled to the signal line, a resistive section connected to the coupled line, and a ground via connected to the resistive section. The equalizer reduces power of the data signal in a frequency range where a frequency response characteristic of the optical modulator driver exhibits a peaking, so as to reduce waveform jitter in a data signal input to the optical modulator from the optical modulator driver.

According to another aspect of the present invention, an optical transmitter includes an optical modulator driver which amplifies a data signal, an equalizer which receives output of the optical modulator driver, and an optical modulator which converts output of the equalizer into an optical signal and outputs the optical signal. The equalizer has a signal line for transmitting the data signal, a coupled line electromagnetically coupled to the signal line, a resistive section connected to the coupled line, and a ground via connected to the resistive section. The equalizer reduces output power of the optical modulator driver in a frequency range where a frequency response characteristic of the optical modulator driver exhibits a peaking.

Other and further objects, features and advantages of the invention will appear more fully from the following description.

### BRIEF DESCRIPTION OF THE DRAWINGS

FIG. 1 is a block diagram showing an optical transmitter in accordance with a first embodiment of the present invention;

FIG. 2 is a plan view showing the positive phase equalizer and the negative phase equalizer;

FIG. 3 is an equivalent circuit diagram of the positive phase equalizer;

FIG. 4 is a diagram showing the frequency response characteristic of the optical modulator driver of the first embodiment;

FIG. 5 is a diagram showing the frequency response characteristic of the positive phase equalizer;

FIG. 6 is a diagram showing an eye diagram of a signal exhibiting waveform jitter;

FIG. 7 is a diagram showing the positive phase equalizer and the negative phase equalizer of the optical transmitter of the second embodiment;

FIG. 8 is a diagram showing the frequency response characteristics of the positive phase equalizer and the negative phase equalizer of the second embodiment;

FIG. 9 is a diagram showing the reflection characteristics S11 of the positive phase and negative phase equalizers of the second embodiment;

FIG. 10 is a diagram showing the positive phase equalizer and the negative phase equalizer of the third embodiment;

FIG. 11 is a diagram showing a positive phase equalizer and a negative phase equalizer, which are presented for comparison purposes;

FIG. 12 is a diagram showing the frequency response characteristics of the DC coupled equalizer and the AC coupled equalizer;

FIG. 13 is a diagram showing the reflection characteristics of the DC coupled equalizer and the AC coupled equalizer; and

FIG. 14 is a diagram showing the optical transmitter of the fourth embodiment.

### DETAILED DESCRIPTION OF THE PREFERRED EMBODIMENTS

### First Embodiment

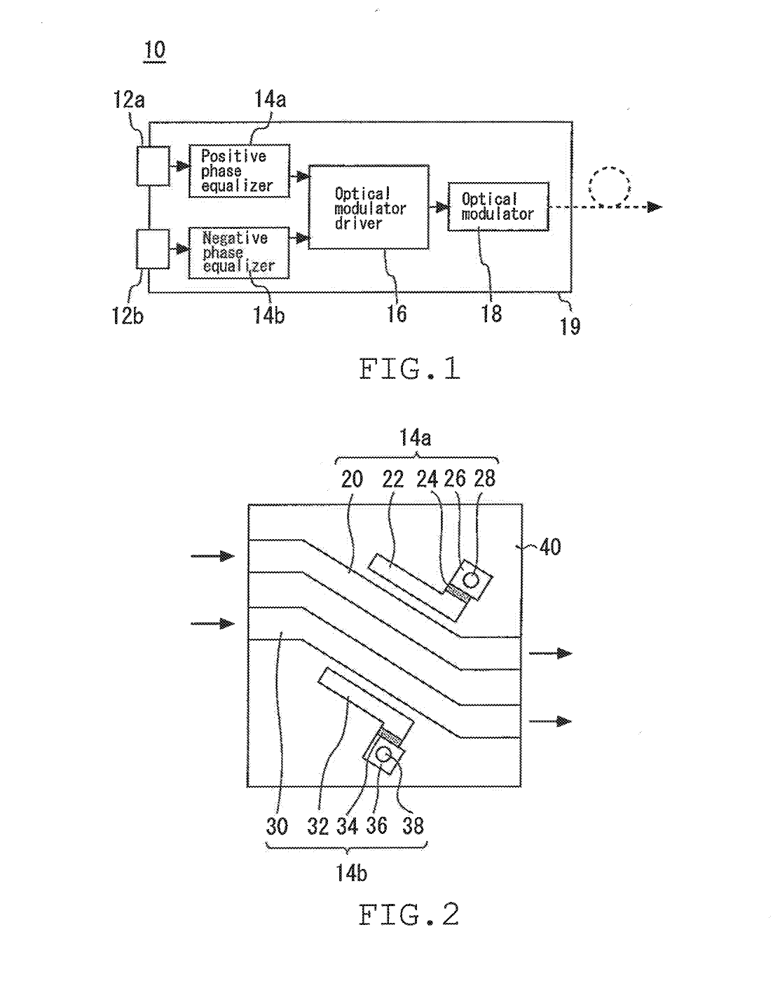

FIG. 1 is a block diagram showing an optical transmitter in accordance with a first embodiment of the present invention. The optical transmitter 10 has a positive phase signal input terminal 12a and a negative phase signal input terminal 12b for receiving a positive phase signal (or normal phase signal) and a negative phase signal (or reversed phase signal), respectively, which make up a data signal. The positive phase signal input terminal 12a is connected to a positive phase equalizer 14a. The negative phase signal input terminal 12b is connected to a negative phase equalizer 14b.

The output terminals of the positive phase equalizer 14a and the negative phase equalizer 14b are connected to an optical modulator driver 16. The optical modulator driver 16 amplifies and adds together the outputs of the positive phase equalizer 14a and the negative phase equalizer 14b and then outputs the resulting signal. The output terminal of the optical modulator driver 16 is connected to an optical modulator 18. The optical modulator 18 converts the output of the optical modulator driver 16 into an optical signal and outputs the optical signal. The optical modulator 18 has a reduced size and reduced power consumption since it is made up of an electroabsorption modulator and a semiconductor laser device monolithically integrated together. The positive phase equalizer 14a, the negative phase equalizer 14b, the optical modulator driver 16, and the optical modulator 18 are hermetically sealed by a package 19.

FIG. 2 is a plan view showing the positive phase equalizer and the negative phase equalizer. The positive phase equalizer 14a has a positive phase signal line 20 for transmitting a positive phase signal. A positive phase coupled line 22 is electromagnetically coupled to the positive phase signal line 20. A positive phase resistive section 24 is connected to the positive phase coupled line 22. A ground via 28 is connected to the positive phase resistive section 24 through a metal film 26.

The negative phase equalizer 14b has a negative phase signal line 30 for transmitting a negative phase signal. A negative phase coupled line 32 is electromagnetically coupled to the negative phase signal line 30. A negative phase resistive section 34 is connected to the negative phase coupled line 32. A ground via 38 is connected to the negative phase resistive section 34 through a metal film 36. The positive phase equalizer 14a and the negative phase equalizer 14b are formed on a dielectric substrate 40. The dielectric substrate 40 is formed by sintering alumina ceramic material.

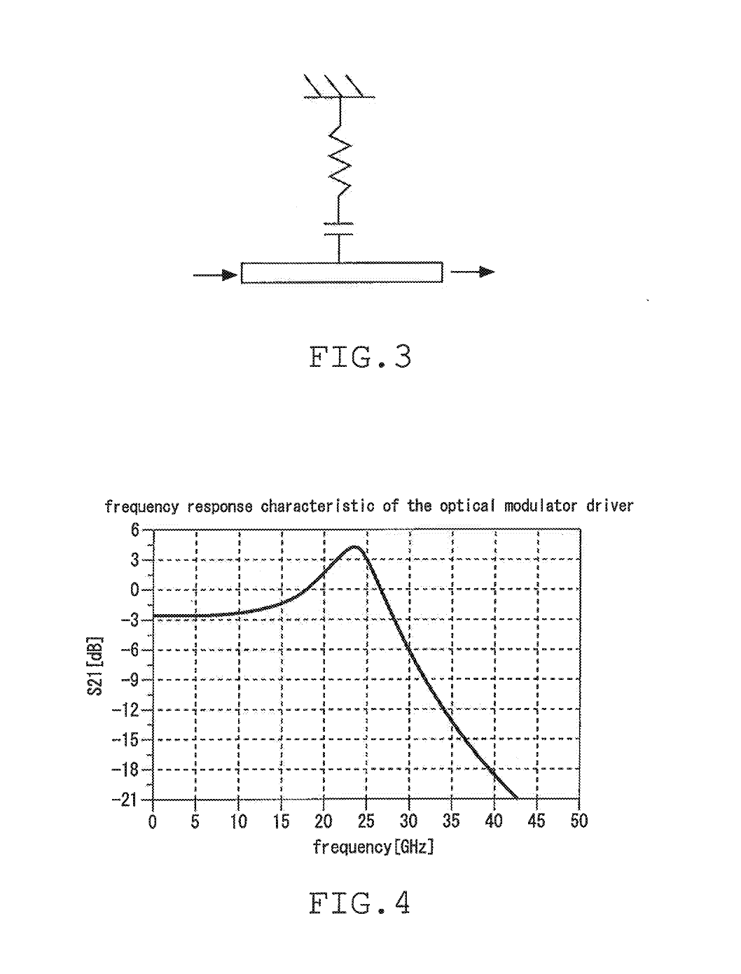

The positive phase signal line 20, the positive phase coupled line 22, the positive phase resistive section 24, the negative phase signal line 30, the negative phase coupled line 32, and the negative phase resistive section 34 are all formed on the dielectric substrate 40 by metal vapor deposition. The positive phase signal line 20 and the dielectric substrate 40 form a microstrip line, and the negative phase signal line 30 and the dielectric substrate 40 form another microstrip line. Each microstrip line has a characteristic impedance of 50 Ω to reduce losses. FIG. 3 is an equivalent circuit diagram of the positive phase equalizer 14a. The negative phase equalizer 14b can also be represented by the same equivalent circuit. The positive phase equalizer 14a and the negative phase equalizer 14b function as notch filters for reducing the power of the data signal in a predetermined frequency range.

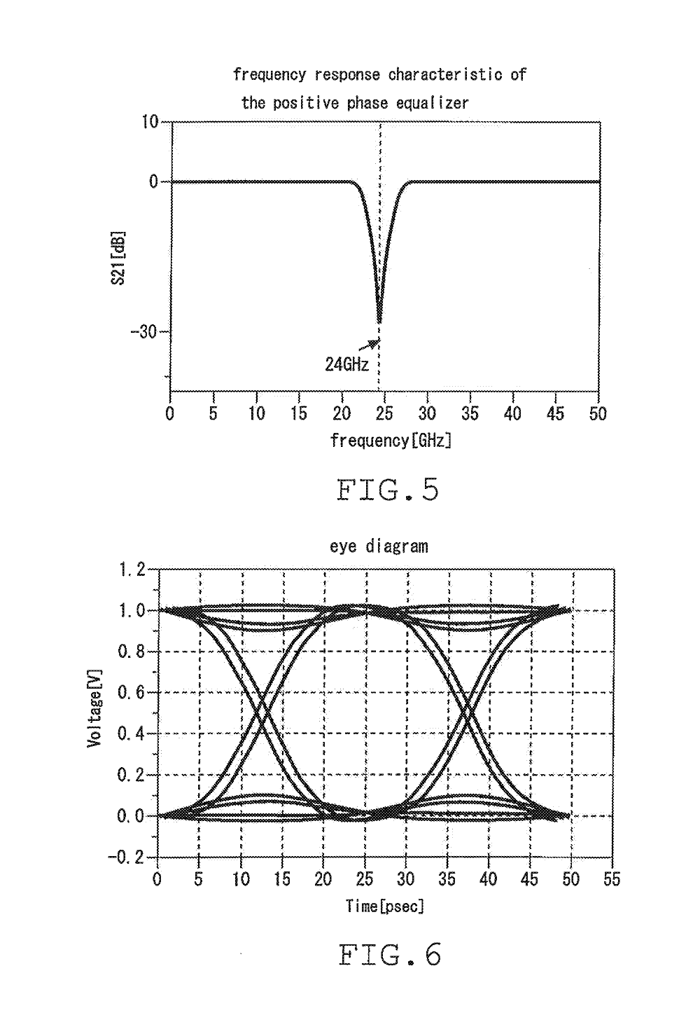

FIG. 4 is a diagram showing the frequency response characteristic of the optical modulator driver of the first embodiment. The frequency response characteristic of the optical modulator driver 16 exhibits a peaking centered around approximately 24 GHz. Therefore, the positive phase equalizer 14a and the negative phase equalizer 14b are configured so as to reduce the power of the data signal in the frequency range where the frequency response characteristic of the optical modulator driver 16 exhibits this peaking. FIG. 5 is a diagram showing the frequency response characteristic of the positive phase equalizer. The negative phase equalizer also has the same frequency response characteristic as the positive phase equalizer. The positive phase equalizer 14a and the negative phase equalizer 14b reduce the power of the data signal in a frequency range centered around 24 GHz.

The operation of the optical transmitter 10 of the first embodiment will be described. The data signal has a bit rate of, e.g., 40 Gbit/s. The data signal is transmitted by a differential transmission system in which the positive phase signal and the negative phase signal of the data signal are transmitted through different transmission lines. In FIG. 1, the arrowed solid lines indicate the flow of the data signal, which is an electrical signal, and the arrowed dashed line indicates an optical signal. The data signal is transmitted to the optical transmitter 10 from a high speed IC such as, e.g., a multiplexer. The positive phase signal is input to the positive phase equalizer 14 through the positive phase signal input terminal 12a. At the same time, the negative phase signal is input to the negative phase equalizer 14b through the negative phase signal input terminal 12b.

The positive phase equalizer 14a and the negative phase equalizer 14b reduce the power of the data signal in the frequency range where the frequency response characteristic of the optical modulator driver 16 exhibits a peaking. The outputs of the positive phase equalizer 14a and the negative phase equalizer 14b are input to the optical modulator driver 16. The optical modulator driver 16 amplifies the data signal and outputs (or supplies) it to the optical modulator 18. The optical modulator 18 converts the data signal into an optical signal which is then output from the optical transmitter 10. Thus, the optical transmitter 10 amplifies the electrical data signal to the desired amplitude and then converts it into an optical signal.

The use of the optical modulator driver 16, which has a peaking in its frequency response characteristic, results in degraded quality of the data signal and occurrence of waveform jitter. FIG. 6 is a diagram showing an eye diagram of a signal exhibiting waveform jitter. It is preferable to suppress waveform jitter, since it causes data errors. Therefore, in the optical transmitter 10 of the first embodiment, the positive phase equalizer 14a and the negative phase equalizer 14b reduce the power of the data signal in the frequency range where the frequency response characteristic of the optical modulator driver 16 exhibits a peaking. This prevents the degradation of the data signal input to the optical modulator 18, thereby preventing waveform jitter.

Thus, the data signal input to the optical modulator driver 16 is adjusted by the positive phase equalizer 14a and the negative phase equalizer 14b, which function as notch filters, so as to prevent the optical modulator 18 from being affected by the peaking characteristic of the optical modulator driver 16. More specifically, the positive phase equalizer 14a and the negative phase equalizer 14b reduce the power of the data signal so as to compensate for the peaking characteristic of the optical modulator driver 16; that is, these equalizers and the optical modulator driver 16 together provide a flat amplification characteristic.

The notch filter functions of the positive phase equalizer 14a and the negative phase equalizer 14b can be easily adjusted by changing the dimensions of the positive phase coupled line 22 and the negative phase coupled line 32 and/or the resistance values of the positive phase resistive section 24 and the negative phase resistive section 34. Further, since the positive phase equalizer 14a and the negative phase equalizer 14b are each formed by capacitive and resistive elements, their characteristics exhibit a reduced temperature dependence and reduced changes over time. Therefore, they can be used for long periods of time. Further, these equalizers can be accurately formed to the desired dimensions without dimensional variations, since metal vapor deposition is used to form the positive phase signal line 20, the positive phase coupled line 22, the positive phase resistive section 24, the negative phase signal line 30, the negative phase coupled line 32, and the negative phase resistive section 34.

The positive phase and negative phase equalizers may have any configuration that allows them to reduce the power of the data signal in the frequency range where the frequency response characteristic of the optical modulator driver 16 exhibits a peaking. Further, in the first embodiment, the positive phase equalizer 14a and the negative phase equalizer 14b function as notch filters for blocking or suppressing the data signal in a particularly narrow frequency range. The reason for this is so that waveform jitter is suppressed without suppressing the data signal in frequency ranges other than the frequency range related to the waveform jitter. This means that if the optical modulator driver 16 exhibits a broad peaking in its frequency response characteristic, then the positive phase and negative phase equalizers may be configured to function as band stop filters, which have a wider stop band than notch filters.

The transmission system by which the data signal is transmitted is not limited to the differential transmission system. For example, if a high transmission rate is not required, an LVDS signal may be used. Further, if the data signal is not divided into positive phase and negative phase signals and is transmitted through a single line, then only one equalizer is required. The optical modulator 18 may be a Mach-Zehnder optical modulator, which can produce an optical waveform that has a high extinction ratio and that provides a low dispersion penalty.

### Second Embodiment

The following description of an optical transmitter in accordance with a second embodiment of the present invention will be primarily limited to the differences from the optical transmitter of the first embodiment. The optical transmitter of the second embodiment is characterized in that the positive phase resistive section and the negative phase resistive section have different resistance values.

The optical modulator driver of the optical transmitter of the second embodiment has different frequency response characteristics for the positive phase and negative phase signals. Specifically, the frequency response characteristic for the positive phase signal exhibits a first peaking, and the frequency response characteristic for the negative phase signal exhibits a second peaking. The first peaking has a greater magnitude than the second peaking.

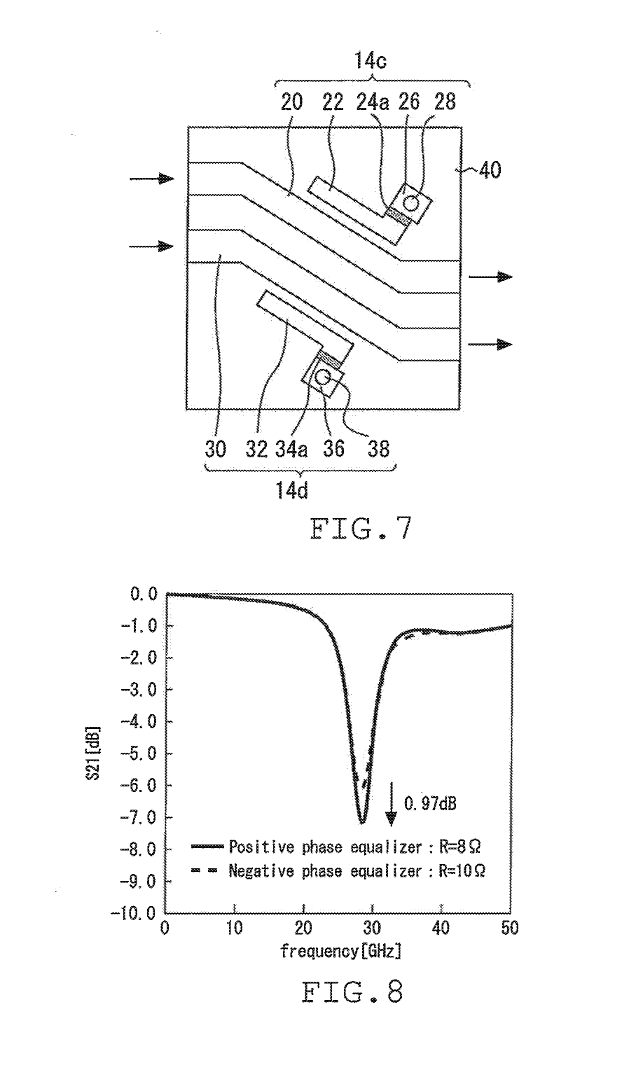

FIG. 7 is a diagram showing the positive phase equalizer 14c and the negative phase equalizer 14d of the optical transmitter of the second embodiment. The positive phase resistive section 24a of the positive phase equalizer 14c has an optimal resistance value (8 Ω) for reducing the power of the positive phase signal so as to suppress waveform jitter due to the first peaking. The negative phase resistive section 34a of the negative phase equalizer 14d, on the other hand, has an optimal resistance value (10 Ω) for reducing the power of the negative phase signal so as to suppress waveform jitter due to the second peaking.

FIG. 8 is a diagram showing the frequency response characteristics (transmission characteristics S21) of the positive phase equalizer and the negative phase equalizer of the second embodiment. As can be seen from FIG. 8, these equalizers have different filtering characteristics, since the positive phase resistive section 24a and the negative phase resistive section 34a have different resistance values. The positive phase equalizer 14c significantly reduces the power of the positive phase signal in the frequency range where the first peaking occurs, thereby suppressing waveform jitter due to the first peaking. Further, the negative phase equalizer 14d slightly reduces the power of the negative phase signal in the frequency range where the second peaking occurs, thereby suppressing waveform jitter due to the second peaking. Thus, the optical transmitter of the second embodiment can suppress waveform jitter even though its optical modulator driver has different frequency response characteristics for the positive phase and negative phase signals.

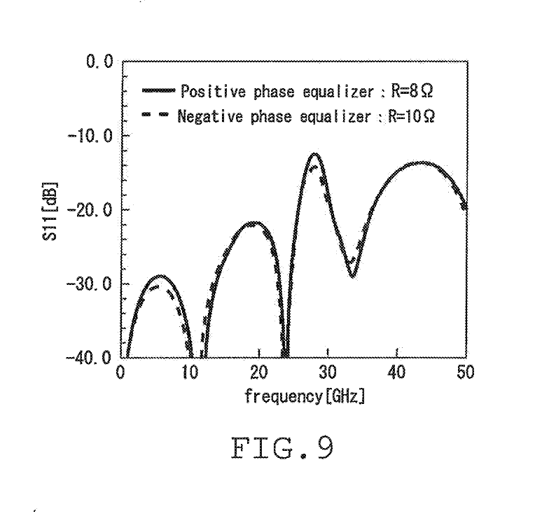

It should be noted that since the positive phase resistive section 24a of the positive phase equalizer 14c and the negative phase resistive section 34a of the negative phase equalizer 14d have different resistance values, these equalizers have different reflection characteristics. FIG. 9 is a diagram showing the reflection characteristics S11 of the positive phase and negative phase equalizers of the second embodiment.

Thus, the optical modulator driver of the optical transmitter of the second embodiment has different frequency response characteristics for the positive phase and negative phase signals, and these frequency response characteristics for the positive phase and negative phase signals exhibit the first peaking and the second peaking, respectively. In order to suppress waveform jitter, the optical transmitter is configured so as to apply different optimal filtering to each signal (i.e., reduce the power of the positive phase and negative phase signals by different amounts). Specifically, in the above example, the positive phase and negative phase equalizers are provided with different resistance values to accomplish this. However, parameters other than the resistance values of these equalizers may be varied to achieve the same effect.

For example, the length of the positive phase coupled line 22 as measured along the positive phase signal line 20 may be selected to differ from the length of the negative phase coupled line 32 as measured along the negative phase signal line 30. Further, the positive phase coupled line 22 and the negative phase coupled line 32 may have different widths. Further, the positive phase coupled line 22 may be spaced from the positive phase signal line 20 a different distance than the negative phase coupled line 32 is spaced from the negative phase signal line 30. Further, the positive phase coupled line 22 and the negative phase coupled line 32 may be spaced different distances from the optical modulator driver.

### Third Embodiment

The following description of an optical transmitter in accordance with a third embodiment of the present invention will be primarily limited to the differences from the optical transmitter of the first embodiment. The optical transmitter of the third embodiment is characterized in that a first plurality of coupled lines are electromagnetically coupled to the positive phase equalizer signal line and a second plurality of coupled lines are electromagnetically coupled to the negative phase equalizer signal line.

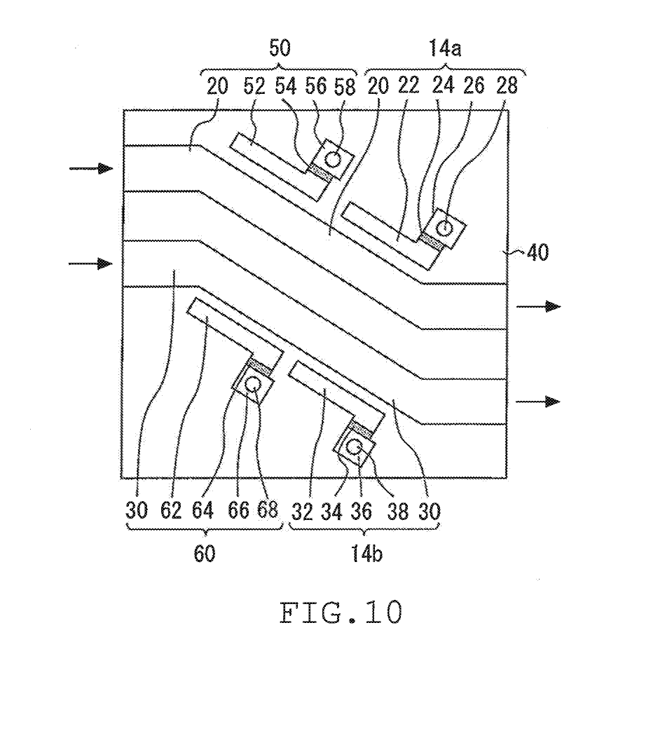

FIG. 10 is a diagram showing the positive phase equalizer and the negative phase equalizer of the third embodiment. An additional positive phase coupled line 52 is electromagnetically coupled to the positive phase signal line 20. An additional positive phase resistive section 54 is connected to the additional positive phase coupled line 52. An additional ground via 58 is connected to the additional positive phase resistive section 54 through a metal section 56. The additional positive phase equalizer 50 is formed by the positive phase signal line 20, the additional positive phase coupled line 52, the additional positive phase resistive section 54, the metal section 56, and the additional ground via 58. Thus, two equalizers, namely the positive phase equalizer 14a and an additional positive phase equalizer 50, are provided for the positive phase signal.

An additional negative phase coupled line 62 is electromagnetically coupled to the negative phase signal line 30. An additional negative phase resistive section 64 is connected to the additional negative phase coupled line 62. An additional ground via 68 is connected to the additional negative phase resistive section 64 through a metal section 66. The additional negative phase equalizer 60 is formed by the negative phase signal line 30, the additional negative phase coupled line 62, the additional negative phase resistive section 64, the metal section 66, and the additional ground via 68. Thus, two equalizers, namely the negative phase equalizer 14b and an additional negative phase equalizer 60, are provided for the negative phase signal. It should be noted that the positive phase resistive section 24, the additional positive phase resistive section 54, the negative phase resistive section 34, and the additional negative phase resistive section 64 have a resistance value of 9 Ω.

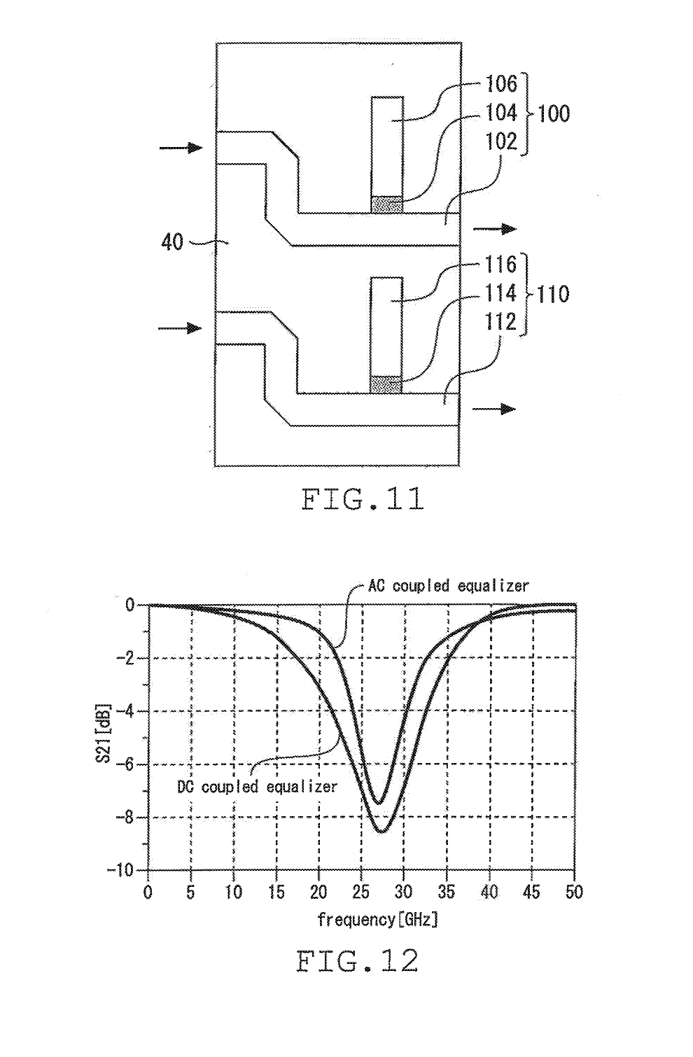

The following description will be directed to a comparative example. FIG. 11 is a diagram showing a positive phase equalizer 100 and a negative phase equalizer 110, which are presented for comparison purposes. The positive phase equalizer 100 has a resistive section 104 directly connected to a positive phase signal line 102. A metal section 106 is connected to the resistive section 104. The negative phase equalizer 110, on the other hand, has a resistive section 114 directly connected to a negative phase signal line 112. A metal section 116 is connected to the resistive section 114. The resistive sections 104 and 114 have a resistance value of 20 Ω. The positive phase equalizer 100 and the negative phase equalizer 110 for comparison are herein referred to collectively as a “DC coupled equalizer.” On the other hand, the positive phase equalizer 14a, the additional positive phase equalizer 50, the negative phase equalizer 14b, and the additional negative phase equalizer 60 of the third embodiment are herein referred to collectively as an “AC coupled equalizer.”

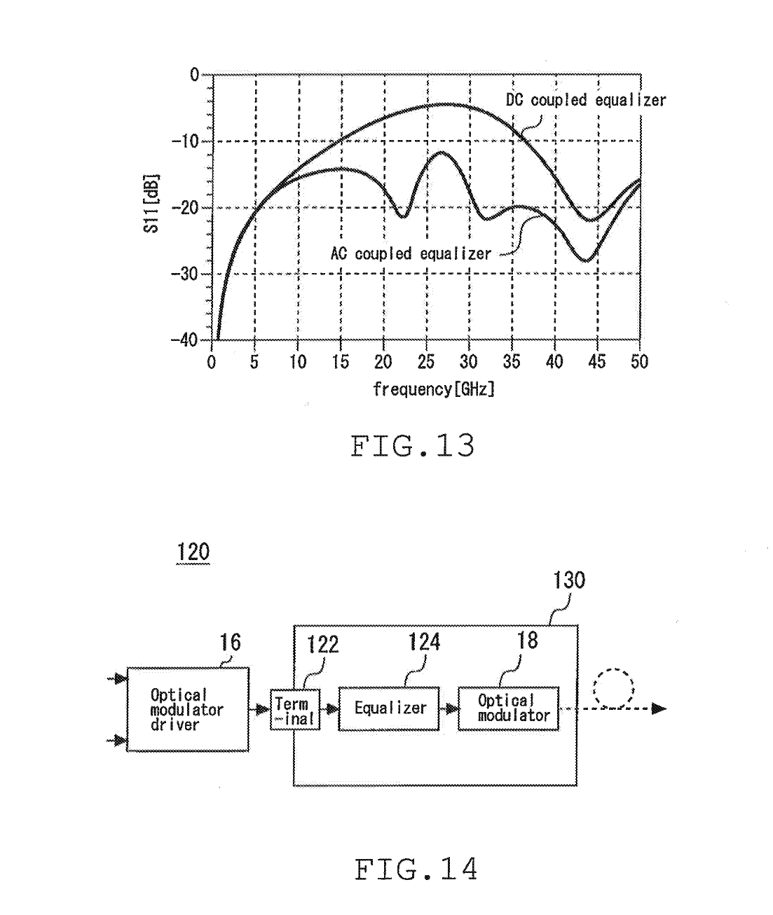

FIG. 12 is a diagram showing the frequency response characteristics of the DC coupled equalizer and the AC coupled equalizer. As shown, the AC coupled equalizer has a better transmission characteristic than the DC coupled equalizer at low frequencies. FIG. 13 is a diagram showing the reflection characteristics of the DC coupled equalizer and the AC coupled equalizer. As shown, the AC coupled equalizer has a better reflection characteristic than the DC coupled equalizer over a wide frequency range.

The optical transmitter of the third embodiment has a better transmission characteristic and a better reflection characteristic than optical transmitters using a DC coupled equalizer. Further, the optical transmitter of the third embodiment is provided with two equalizers for each of the positive phase and negative phase signals, making it possible to more effectively reduce the power of the data signal in a predetermined frequency range. Therefore, this configuration of the optical transmitter is particularly effective in compensating for a pronounced peaking in the frequency response characteristic of the optical modulator driver.

### Fourth Embodiment

The following description of an optical transmitter in accordance with a fourth embodiment of the present invention will be primarily limited to the differences from the optical transmitter of the first embodiment. The optical transmitter of the fourth embodiment is characterized in that the equalizer is connected to the output side of the optical modulator driver.

FIG. 14 is a diagram showing the optical transmitter of the fourth embodiment. This optical transmitter 120 has an optical modulator driver 16. The output of the optical modulator driver 16 is input to an equalizer 124 through a terminal 122. The output of the equalizer 124 is converted by the optical modulator 18 into an optical signal which is then output from the optical transmitter 120.

The equalizer 124 functions as a notch filter for reducing the output power of the optical modulator driver 16 in the frequency range where the frequency response characteristic of the optical modulator driver 16 exhibits a peaking. The equalizer 124 may be any one of the positive phase and negative phase equalizers described in connection with the first to third embodiments. The equalizer 124 and the optical modulator 18 are hermetically sealed by a package 130.

In the optical transmitter of the fourth embodiment, the positive phase and negative phase signals are received and combined by the optical modulator driver, and the output power of the optical modulator driver is reduced in a predetermined frequency range by the equalizer. This circuit configuration requires only one equalizer, and this equalizer may be configured as any one of the positive phase and negative phase equalizers described in connection with the first to third embodiments, thereby achieving the advantages of the present invention described above. This means that the equalizer of the fourth embodiment can be of a reduced size.

The optical transmitter of the present invention is provided with an equalizer to reduce the power of the input data signal in the frequency range where the frequency response characteristic of the optical modulator driver exhibits a peaking, thereby reducing waveform jitter.

Obviously many modifications and variations of the present invention are possible in the light of the above teachings. It is therefore to be understood that within the scope of the appended claims the invention may be practiced otherwise than as specifically described.

The entire disclosure of Japanese Patent Application No. 2012-142078, filed on Jun. 25, 2012, including specification, claims, drawings, and summary, on which the Convention priority of the present application is based, is incorporated herein by reference in its entirety.

1. An optical transmitter comprising:
an equalizer which receives a data signal;
an optical modulator driver having a frequency response characteristic and which amplifies an output signal of said equalizer; and
an optical modulator which converts an output signal of said optical modulator driver into an optical signal and outputs the optical signal, wherein
said equalizer has a signal line for transmitting the data signal, a coupled line electromagnetically coupled to said signal line, a resistive section connected to said coupled line, and a ground via connected to said resistive section, and
said equalizer reduces power of the data signal in a frequency range where the frequency response characteristic of said optical modulator driver exhibits peaking, to reduce waveform jitter in the output signal of said optical modulator driver that is input to said optical modulator.

2. The optical transmitter according to claim 1, wherein:
said equalizer has a positive phase equalizer and a negative phase equalizer which respectively receive a positive phase signal and a negative phase signal, respectively, of the data signal;
said optical modulator driver amplifies and adds together output signals of said positive phase equalizer and said negative phase equalizer to produce and output a single output signal of said optical modulator driver;
said optical modulator driver has a first frequency response characteristic for the positive phase signal and a second frequency response characteristic for the negative phase signal, and the first and second frequency response characteristics exhibit first peaking and second peaking, respectively;
said positive phase equalizer reduces power of the positive phase signal to reduce waveform jitter, due to the first peaking, in the output signal of said optical modulator driver that is input to said optical modulator; and
said negative phase equalizer reduces power of the negative phase signal to reduce waveform jitter, due to the second peaking, in the output signal of optical modulator driver that is input to said optical modulator.

3. The optical transmitter according to claim 2, wherein:
said positive phase equalizer has a positive phase signal line for transmitting the positive phase signal, a positive phase coupled line electromagnetically coupled to said positive phase signal line, a positive phase resistive section connected to said positive phase coupled line, and a ground via connected to said positive phase resistive section; and
said negative phase equalizer has a negative phase signal line for transmitting the negative phase signal, a negative phase coupled line electromagnetically coupled to said negative phase signal line, a negative phase resistive section connected to said negative phase coupled line, and a ground via connected to said negative phase resistive section.

4. The optical transmitter according to claim 3, wherein:
the first peaking and the second peaking have different magnitudes; and
length of said positive phase coupled line, as measured along said positive phase signal line, differs from length of said negative phase coupled line, as measured along said negative phase signal line.

5. The optical transmitter according to claim 3, wherein:
the first peaking and the second peaking have different magnitudes; and
said positive phase coupled line and said negative phase coupled line have different widths.

6. The optical transmitter according to claim 3, wherein:
the first peaking and the second peaking have different magnitudes; and
said positive phase resistive section and said negative phase resistive section have different resistance values.

7. The optical transmitter according to claim 3, wherein:
the first peaking and the second peaking have different magnitudes; and
said positive phase coupled line is spaced from said positive phase signal line a different distance than said negative phase coupled line is spaced from said negative phase signal line.

8. The optical transmitter according to claim 3, wherein:
the first peaking and the second peaking have different magnitudes; and
said positive phase coupled line and said negative phase coupled line are spaced different distances from said optical modulator driver.

9. The optical transmitter according to claim 1, wherein said equalizer further has an additional coupled line electromagnetically coupled to said signal line, an additional resistive section connected to said additional coupled line, and an additional ground via connected to said additional resistive section.

10. An optical transmitter comprising:
an optical modulator driver having a frequency response characteristic and which amplifies a data signal;
an equalizer which receives an output signal of said optical modulator driver; and
an optical modulator which converts the output signal of said equalizer into an optical signal and outputs the optical signal, wherein
said equalizer has a signal line for transmitting the data signal, a coupled line electromagnetically coupled to said signal line, a resistive section connected to said coupled line, and a ground via connected to said resistive section, and
said equalizer reduces output power of said optical modulator driver in a frequency range where the frequency response characteristic of said optical modulator driver exhibits peaking.

11. The optical transmitter according to claim 1, wherein said optical modulator includes an electroabsorption modulator and a semiconductor laser device which are monolithically integrated together.

12. The optical transmitter according to claim 1, wherein said optical modulator is a Mach-Zehnder optical modulator.
